(19) United States
(12) Patent Application Publication
(10) Pub. No.: US 2007/0071979 A1
(43) Pub. Date: Mar. 29, 2007

(54) Magnetic material, magnet, and rotating machine

(76) Inventors: Matahiro Komuro, Hitachi (JP); Yuichi Satsu, Hitachi (JP); Yuzo Kozono, Hitachiota (JP); Yasuo Kondo, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/525,928

(22) Filed: Sep. 25, 2006

(30) Foreign Application Priority Data
Sep. 26, 2005 (JP) 2005-277032
Jun. 28, 2006 (JP) 2006-177488

(51) Int. Cl. B32B 5/16; B32B 15/00; H01F 1/04

(52) U.S. Cl. 428/403; 428/692.1; 428/404; 428/693.1; 428/701; 428/702; 252/62.59; 252/62.63; 252/62.64; 252/62.55

(57) ABSTRACT

A magnetic material is including magnetic particles including a rare earth element, wherein a fluorine compound including an alkaline earth element or a rare earth element is formed on a surface of the magnetic particles, an oxygen concentration of the fluorine compound is higher than an oxygen concentration of the magnetic particle and the fluorine compound includes at least one type of element selected from the group consisting of the Li, Mg, Ca, Sc, V, Cr, Mn, Fe, Co, Ni, Zn, Al, Ga, Sr, Y, Zr, Nb, Ag, In, Sn, Ba, La, Ce, Pr, Nd, Sm, Eu, Gd, Tb, Dy, Ho, Er, Tm, Yb, Lu, Pb, and Bi elements.

### CLAIM OF PRIORITY

The present application claims priority from Japanese application Ser. No.2005-277032, filed on Sep. 26, 2005, and Japanese application Ser. No.2006-177488, filed on Jun. 28, 2006, the contents of which are hereby incorporated by references into this application.

### BACKGROUND OF THE INVENTION

1. (Field of Technology)

The present invention relates to a magnetic material, a magnet, and a rotating machine.

2. (Background of Art)

A conventional rare earth sintered magnet including a fluorine compound is described in Japanese application patent laid-open Publication No. 2003-282312. In the above prior art, fluorine compounds form a grain boundary phase in a powder state; the size of a particle in the grain boundary phase is several micrometers. When the coercive force of this type of magnet is increased, the energy product is largely reduced. The grain boundary phase in the powder state is mainly formed on a grain boundary. There is no description for the structure and composition of the fluorine compound in the prior art.

[Patent Document 1] Japanese Application Patent Laid-Open Publication No. 2003-282312

### SUMMARY OF THE INVENTION

Table 3 in Patent Document 1 shows the magnetic properties of a sintered magnet fabricated by adding powder for use in a NdFeB sintered magnet and DyF₃, which is a fluorine compound. When 5% of DyF₃ by weight is added, the value of the residual magnetic flux density (Br) is 11.9 kG, which is an about 9.8% reduction compared with the value (13.2 kG) when DyF₃ is not added. The reduction in the residual magnetic flux density causes the energy product ((BH)_{MAX}) to be greatly reduced. Although the coercive force is increased, the energy product is low, so it is difficult to use this type of magnet in a magnetic circuit that requires a high magnetic flux or in a rotating machine that requires a high torque.

An object of the present invention is to provide a magnetic particle having a fluorine compound on the surface thereof and a magnet having this type of magnetic particles, for which a reduction in the residual magnetic flux density and a reduction in the energy product are suppressed. Another object of the present invention is to provide a highly efficient rotating machine in which magnets of this type are used.

A feature of the present invention to achieve the above objects is that a magnetic material is made of magnetic particles, each of which includes a rare earth element; a fluorine compound including an alkaline earth element or rare earth element is formed on the surface of the magnetic particle; the fluorine compound has a higher oxygen concentration than the magnetic particle.

Other features of the present invention will be described in the detailed description of the invention that follows.

According to the present invention, a magnetic particle having a fluorine compound on the surface and a magnet having this type of magnetic particles, for which a reduction in the residual magnetic flux density and a reduction in the energy product are suppressed, can be provided. According to the present invention, a highly efficient rotating machine in which magnets of this type are used can be provided.

### BRIEF DESCRIPTION OF THE DRAWINGS

FIG. 1 shows a TEM image of a cross section of NdFeB on which a Dy fluorine compound film is formed.

FIGS. 2A, 2B, 2C, and 2D show TEM-EDX analysis results at various points in the TEM image.

FIG. 3 shows an electron diffraction image of DyF₂.

FIG. 4 shows XRD patterns of a NdFeB—DyF₂ magnetic particle

FIG. 5 shows a relation between the oxygen concentration ratio and the residual magnetic flux density near an interface.

FIG. 6 shows other relation between the oxygen concentration ratio and the residual magnetic flux density near an interface.

FIG. 7 shows a schematic cross-sectional view of a rotating machine as an embodiment of the present invention.

FIG. 8 shows images obtained by analyzing surfaces near interfaces with an electron microscope.

### DETAILED DESCRIPTION OF THE INVENTION

To achieve the above objects, it is necessary, for example, to form a plate-like fluorine compound on a grain boundary so as to enlarge the interface between the fluorine compound and main phase, to reduce the thickness of the fluorine compound, or to make the fluorine compound a strong magnetic phase. In the first method, it is effective to use a technique by which plate-like or flat powder is obtained when powder is formed from the fluorine compound. In the case of NdF₃ in Patent Document 1 as the prior art, NdF₃ powder with an average particle diameter of 0.2 μm and NdFeB alloy powder are mixed by use of an automatic mortar, but there is no description for the shape of the fluorine compound; the shape of the fluorine compound after sintering is a lump. An example in the technique in the present invention, the powder of the fluorine compound is layer-like powder after a magnet is fabricated. To make the shape of the fluorine compound powder like a layer after a magnet is fabricated, a mixture of fluorine compound powder and magnetic particles is supplied between twin rolls at a temperature of 300° C. to 600° C. A pressurizing force of 100 kg/cm² or more was then applied to the mixture. After each magnetic particle is pressurized by the twin rollers, a layer-like fluorine compound is formed on the surface of the magnetic particle. Surface treatment can be used as another technique to form a layer-like fluorine compound. The surface treatment is a technique to apply a fluorine compound or a fluorine compound including at least one type of element selected from the group consisting of alkaline metal elements, alkaline earth elements, and rare earth elements to the surface of a magnetic particle. Gelled fluorine compounds are milled in an alcohol solvent, the resulting fluorine compound powder is applied to the surfaces of magnetic particles, and then the solvent is removed by heating. The solvent is removed by heat treatment at 200° C. to 400° C. Then oxygen, rare earth elements, and fluorine compound constituting elements diffuse between the fluorine compounds and magnetic particles by heat treatment at 500° C. to 800° C. A magnetic particle includes oxygen at a concentration of 10 to 5000 ppm. As other impurity elements, light elements such as H, C, P, Si, and Al are included. Oxygen included in a magnetic particle exists in the forms of not only rare earth oxides and oxides of light elements such as Si and Al but also a parent phase and a phase including oxygen in a composition that is deviated from the stoichiometric composition. A phase including this type of oxygen reduces the magnetism of the magnetic particle and affects the shape of a magnetization curve. Specifically, there are reductions in the residual magnetic flux density, the anisotropic magnetic field, the angularity of a magnetization curve, and the coercive force, increases in the irreversible demagnetization ratio and thermal demagnetization, a change in the magnetization property, deterioration in corrosion, and a reduction in mechanical properties, reducing the reliability of the magnet. As described above, oxygen affects many properties, so processes for preventing oxygen from remaining in the magnetic particle have been considered. However, it has not been clarified that a fluorine compound is formed on the surface of a magnetic particle and then oxygen in the magnetic particle is removed. When a fluorine compound is formed on the surface of a magnetic particle including oxygen and then heating at a temperature of 500° C. or more is performed, oxygen diffusion occurs. In many cases, the oxide in the magnetic particle is combined with a rare earth element in the magnetic particle, but the oxygen diffuses into the fluorine compound due to heating, forming an oxygen-fluorine compound. To form a rare earth fluorine compound on the surface of a magnetic particle, REF₃ is developed by heat treatment at 400° C. or lower and then heated and held for 30 minutes under a degree of vacuum of 1×10⁻⁴ torr at temperatures of 500° C. to 800° C. This heat treatment causes the oxygen in the magnetic particle to diffuse into the fluorine compound. At the same time, the rare earth element in the magnetic particle diffuses, developing REF₂ or REOF. The crystalline structures of the fluorine compound and oxygen-fluorine compound of this type are face-centered cubic lattices, the lattice constant being 0.54 nm to 0.60 nm. When the oxygen in the magnetic particle is removed, there are benefits in the development of a fluorine compound or oxygen-fluorine compound, which include increases in the residual magnetic flux density, the coercive force, the angularity of a magnetization curve, the thermal demagnetization property, the magnetization property, anisotropism, and resistance to corrosion. The oxygen concentration and rare earth element concentration on the surface of the magnetic particle differ due to the diffusion of the oxygen and rare earth element before and after the fluorine compound is formed.

[First Embodiment]

A NdFeB alloy is a powder with a particle diameter of 1 to 1000 μm to which hydrogenation and dehydrogenation processes have been applied. The coercive force of the powder is 16 kOe at room temperature. A fluorine compound to be mixed with this NdFeB (the main phase is Nd₂Fe₁₄B) is NdF₃. Raw powder, NdF₃, is milled in advance to an average particle diameter of 0.01 to 100 μm. A mixture of the NdFeB powder and NdF₃ is supplied between twin rolls. To make the shape of the fluorine compound powder like a layer, the roll surface temperature is raised to 300° C. to 600° C., allowing the NdFeB powder and fluorine compound to be deformed easily by the twin rolls. The fluorine compound and the NdFeB powder are deformed by the twin rollers into a flat shape. The pressurizing force was 100 kg/cm² or more. A layer-like fluorine compound is formed on the surface of the magnetic particle pressurized by the twin roller. A fluorine compound may be further mixed and the mixture may be pressurized with the twin rollers, as necessary. In addition to NdF₃, the following fluorine compound can be mixed: LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, NdF₃, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂, BiF₃, LaF₂, LaF₃, CeF₂, CeF₃, or GdF₃. Mixed powders including these fluorine compounds and oxygen-fluorine compounds in which oxygen is combined with these fluorine compounds can also be formed on the surface of the NdFeB powder in the form of a layer. For the magnetic particle which has been heated and pressurized by the twin rolls, a local distortion remains on the powder due to a stress applied by the pressurization. It is assumed that the local distortion promotes diffusion on the interface between the magnetic particle and fluorine compound. The interface between NdF₃ and the magnetic particle differs depending on the roll surface temperature; the interface is NdF₃/Nd₂Fe₁₄B, a NdF₃/Nd-rich phase, NdF₃/Nd₂O₃, or the like at a temperature of 400° C. or below. When the roll surface temperature is above 400° C., part of NdF₃ reacts with the magnetic particle, forming NdF₂. At the same time, NdOF is formed. Oxygen also enters the above NdF₂; oxygen and the rare earth element in the magnetic particle diffuse into the fluorine compound on a side higher than 400° C. This diffusion reduces the oxygen concentration in the magnetic particle, and any of the effects of increasing the residual magnetic flux density or coercive force, improving the angularity of a magnetization curve, reducing thermal demagnetization, etc. can be confirmed.

[Second Embodiment]

Treatment liquid for forming a dysprosium (Dy) fluorine compound coating films was prepared as follows:

(1) Four grams of Dy acetate or Dy nitrate, which is salt with high solubility, was added to 100 mL of water. The salt was completely dissolved by using a shaker or ultrasonic agitator.

(2) Hydrofluoric acid diluted to about 10% was gradually added by an equivalent for a chemical reaction by which DyF₃ is created.

(3) The solution in which gelled DyF₃ was precipitated was agitated by an ultrasonic agitator for one hour or more.

(4) Centrifugal separation was performed at a rotational speed of 4000 rpm. Then supernatant fluid was removed and methanol was added by almost the same amount.

(5) The methanol solution including gelled DyF₃ was agitated to form a complete suspension. The suspension was agitated by an ultrasonic agitator for one hour or more.

(6) Operation in (4) and (5) was repeated 4 times until negative ions such as acetate ions or nitrate ions were no longer detected.

(7) Slightly suspended, sol-state DyF₃ was obtained. A methanol solution including DyF₃ with a concentration of 1 g/15 mL was used as the treatment liquid.

Next, NdFeB alloy powder or SmCo alloy powder was used as rare earth magnet magnetic particles. The NdFeB alloy is a Fe alloy including at least one type of rare earth elements or an alloy including at least one type of rare earth elements and metalloid elements. The SmCo alloy is a Co alloy including at least one type of rare earth elements. Co alloys of this type include alloys to which various types of additive elements are added. The rare earth magnet magnetic particles have an average particle diameter of 1 to 100 μm and magnetically anisotropic. Processes for forming rare earth fluorine compound coating films or alkaline earth metal fluorine compound coating films on rare earth magnet magnetic particles were practiced by the procedure below.

(1) When the average particle diameter is 10 μm, 15 mL of DyF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which DyF₃ coating films were formed, were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were moved to a container, and then heated at 400° C. to 800° C. under a reduced pressure of 1×10⁻⁵ torr.

(5) The magnetic properties of the rare earth magnet magnetic particles, for which heat treatment were performed in (4), were investigated.

Table 1 lists the measurement results of magnetic properties. Table 1 also lists the magnetic properties of magnetic particles that were formed by performing surface treatment for fluorine compounds including non-Dy elements by a procedure similar to the above procedure. The listed fluorine compounds are main fluorine compounds formed by the surface treatment, and the listed interface phases are phases formed near interfaces between magnetic particles and fluorine compounds. Each of these phases is recognized within about 1000 nm of the interface. The phases can be analyzed through composition analysis based on a transmission electron microscope (TEM), a scanning electron microscope (SEM), and Auger electron spectroscopy (AES), structural analysis, and X-ray diffraction (XRD) patterns. When DyF₃ was formed on the surface of the NdFeB powder as described above, heat treatment was performed for 30 minutes to 1 hour at 400° C. so as to have DyF₂, NdF₂, and NdO₂ develop near the interface. If the heat treatment is further continued at higher temperatures of 500° C. to 800° C., a Fe phase develops on other than the above interface. This type of Fe phase includes a rare earth element, but the oxygen concentration is higher on the fluorine compound side than on the magnetic particle surface. When another fluorine compound is formed by surface treatment, a Fe phase having an oxygen concentration lower than the oxygen concentration in the fluorine compound also develops only at a heat treatment temperature of higher than 400° C. When the heat treatment is performed at a high temperature as described above, rare earth elements, oxygen, and the like diffuse between the fluorine compound and the magnetic particle, part of the oxygen in the magnetic particle diffuses into the fluorine compound, and part of the rare earth elements in the magnetic particle diffuses into the fluorine compound. This diffusion causes the Fe phase (Fe rare earth alloy) to develop on the magnetic particle surface, and part of it is exchange-coupled to NdFeB in the parent phase. The Fe phase includes a rare earth element, and may include an element added to NdFeB, such as Co. Since the Fe phase has a higher saturated magnetic flux density than NdFeB, exchange-coupling to NdFeB makes the magnetization rotation of Fe difficult for an external magnetic field, increasing the residual magnetic flux density. As shown in Table 1, the residual magnetic flux density of a magnetic particle on which a Fe phase is present as an interface layer is larger than the residual magnetic flux density of a magnetic particle on which an identical fluorine compound is formed but there is no Fe phase on the interface. When a Fe phase is developed as an interface phase, the maximum energy product, BHmax, is large. Incidentally, the above Fe phase develops even on a side on which the heat treatment temperature is lower than 400° C. if the heat treatment is carried out for a long period of time.

TABLE 1

| | | | | | | Lattice |
|---|---|---|---|---|---|---|
| | | | | | | constant of |
| Main | | | | iHc | BHmax | fcc phase |
| phase | Fluoride | Interface phase | Br (T) | (kOe) | (MGOe) | (nm) |
| Nd₂Fe₁₄B | Non | — | 12.0 | 12.1 | 25.2 | — |
| Nd₂Fe₁₄B | Lif | NdF3, NdF2 | 10.9 | 12.6 | 22.9 | 0.57 |
| Nd₂Fe₁₄B | Lif | NdF3, NdF2, Fe | 11.3 | 12.4 | 23.7 | 0.56 |
| Nd₂Fe₁₄B | MgF2 | NdOF, NdF3, NdF2 | 10.8 | 12.9 | 22.7 | 0.56 |
| Nd₂Fe₁₄B | MgF2 | NdOF, Nmf3, NdF2, | 11.2 | 12.8 | 23.5 | 0.55 |
| | | Fe | | | | |
| Nd₂Fe₁₄B | CaF2 | NdOF | 10.7 | 15.5 | 22.5 | 0.56 |
| Nd₂Fe₁₄B | CaF2 | NdOF, Fe | 10.9 | 15.7 | 22.9 | 0.55 |
| Nd₂Fe₁₄B | LaF2 | LaF3, LaOF, NdF2, | 10.6 | 16.2 | 22.3 | 0.56 |
| | | La2O3, NdOF | | | | |
| Nd₂Fe₁₄B | LaF2 | LaF3, LaOF, NdF2, | 10.9 | 16.5 | 22.9 | 0.55 |
| | | La2O3, NdOF, Fe | | | | |
| Nd₂Fe₁₄B | LaF3 | LaF2, LaOF, NdF2, | 10.7 | 16.8 | 22.5 | 0.55 |
| | | La2O3, NdOF | | | | |
| Nd₂Fe₁₄B | LaF3 | LaF2, LaOF, NdF2, | 10.9 | 17.1 | 22.9 | 0.55 |
| | | La2O3, NdOF, Fe | | | | |
| Nd₂Fe₁₄B | CeF2 | CeF3, CeOF, NdF2 | 10.5 | 15.4 | 22.1 | 0.57 |
| Nd₂Fe₁₄B | CeF2 | CeF3, CeOF, NdF2, | 10.8 | 15.8 | 22.7 | 0.55 |
| | | Fe | | | | |
| Nd₂Fe₁₄B | CeF3 | CeF2, CeOF, NdF2 | 10.4 | 16.2 | 21.8 | 0.55 |
| Nd₂Fe₁₄B | CeF3 | CeF2, CeOF, NdF2, | 10.9 | 16.1 | 22.9 | 0.55 |
| | | Fe | | | | |
| Nd₂Fe₁₄B | PrF2 | PrF3, PrOF, NdF2 | 10.8 | 16.5 | 22.7 | 0.57 |
| Nd₂Fe₁₄B | PrF2 | PrF3, PrOF, NdF2, | 11.2 | 16.8 | 23.5 | 0.55 |
| | | Fe | | | | |
| Nd₂Fe₁₄B | PrF3 | PrF2, PrOF, NdF2 | 10.9 | 17.4 | 22.9 | 0.55 |
| Nd₂Fe₁₄B | PrF3 | PrF2, PrOF, NdF2, | 11.5 | 17.2 | 24.2 | 0.55 |
| | | Fe | | | | |
| Nd₂Fe₁₄B | NdF2 | NdF3, NdOF | 10.7 | 16.3 | 22.5 | 0.57 |
| Nd₂Fe₁₄B | NdF2 | NdF3, NdOF, Fe | 11.2 | 16.1 | 23.5 | 0.54 |
| Nd₂Fe₁₄B | NdF3 | NdF2, NdOF | 10.5 | 15.4 | 22.1 | 0.57 |
| Nd₂Fe₁₄B | NdF3 | NdF2, NdOF, Fe | 10.9 | 15.2 | 22.9 | 0.54 |
| Nd₂Fe₁₄B | SmF3 | SmF2, NdF2, NdOF | 10.5 | 14.2 | 22.1 | 0.58 |
| Nd₂Fe₁₄B | SmF3 | SmF2, NdF2, NdOF, | 10.8 | 13.9 | 22.7 | 0.54 |
| | | Fe | | | | |
| Nd₂Fe₁₄B | EuF3 | EuF2, EuF2.55, | 10.2 | 13.8 | 21.4 | 0.54 |
| | | NdF2, NdOF | | | | |
| Nd₂Fe₁₄B | EuF3 | EuF2, EuF2.55, | 10.6 | 14.9 | 22.3 | 0.55 |
| | | NdF2, NdOF, Fe | | | | |
| Nd₂Fe₁₄B | GdF3 | GdF2, NdF2, NdOF | 10.3 | 15.5 | 21.6 | 0.57 |
| Nd₂Fe₁₄B | GdF3 | GdF2, NdF2, NdOF, | 10.7 | 15.1 | 22.5 | 0.55 |
| | | Fe | | | | |
| Nd₂Fe₁₄B | TbF3 | TbF2, NdF2, NdO2 | 10.8 | 17.9 | 22.7 | 0.57 |
| Nd₂Fe₁₄B | TbF3 | TbF2, NdF2, NdO2, | 11.5 | 18.1 | 24.2 | 0.55 |
| | | Fe | | | | |
| Nd₂Fe₁₄B | DyF3 | DyF2, NdF2, NdO2 | 10.7 | 18.5 | 22.5 | 0.57 |
| Nd₂Fe₁₄B | DyF3 | DyF2, NdF2, NdO2, | 11.2 | 18.4 | 23.5 | 0.54 |
| | | Fe | | | | |
| Nd₂Fe₁₄B | HoF3 | HoOF, NdO2 | 10.4 | 15.5 | 21.8 | 0.57 |
| Nd₂Fe₁₄B | HoF3 | HoOF, NdO2, Fe | 10.9 | 15.3 | 22.9 | 0.54 |
| Nd₂Fe₁₄B | ErF3 | NdF3, NdF2 | 10.3 | 13.2 | 21.6 | 0.57 |
| Nd₂Fe₁₄B | ErF3 | NdF3, NdF2, Fe | 10.6 | 13.5 | 22.3 | 0.54 |
| Nd₂Fe₁₄B | TmF3 | TmF2, NdF3, NdF2 | 10.4 | 13.0 | 21.8 | 0.57 |
| Nd₂Fe₁₄B | TmF3 | TmF2, NdF3, NdF2, | 10.9 | 13.2 | 22.9 | 0.55 |
| | | Fe | | | | |
| Nd₂Fe₁₄B | YbF2 | YbF2.37, NdOF, | 10.1 | 12.8 | 21.2 | 0.57 |
| | | NdF2 | | | | |
| Nd₂Fe₁₄B | YbF2 | YbF2.37, NdOF, | 10.8 | 12.9 | 22.7 | 0.57 |
| | | NdF2, Fe | | | | |
| Nd₂Fe₁₄B | LuF3 | NdF2, NdF3 | 10.4 | 12.7 | 21.8 | 0.57 |
| Nd₂Fe₁₄B | LuF3 | NdF2, NdF3, Fe | 10.9 | 12.5 | 22.9 | 0.55 |
| Sm₂Co₁₇ | Lif | SmF3, SmF2 | 9.2 | 12.6 | 19.3 | 0.59 |
| Sm₂Co₁₇ | Lif | SmF3, SmF2, Fe | 9.5 | 12.4 | 20.0 | 0.57 |
| Sm₂Co₁₇ | MgF2 | SmOF, SmF3, SmF2 | 9.7 | 12.9 | 20.4 | 0.59 |
| Sm₂Co₁₇ | MgF2 | SmOF, Smf3, SmF2, | 9.5 | 12.8 | 20.0 | 0.57 |
| | | Fe | | | | |
| Sm₂Co₁₇ | CaF2 | SmOF | 9.6 | 15.5 | 20.2 | 0.58 |
| Sm₂Co₁₇ | CaF2 | SmOF, Co | 9.8 | 15.7 | 20.6 | 0.57 |
| Sm₂Co₁₇ | LaF2 | SmF3, SmOF, SmF2, | 9.1 | 16.2 | 19.1 | 0.59 |
| | | SmOF | | | | |
| Sm₂Co₁₇ | LaF2 | SmF3, SmOF, SmF2, | 9.3 | 16.5 | 19.5 | 0.57 |
| | | SmOF, Co | | | | |
| Sm₂Co₁₇ | LaF3 | SmF2, SmOF, SmF2 | 9.4 | 16.8 | 19.7 | 0.60 |
| Sm₂Co₁₇ | LaF3 | LaF2, LaOF, SmF2, | 9.2 | 17.1 | 19.3 | 0.59 |
| | | La2O3, SmOF, Co | | | | |
| Sm₂Co₁₇ | CeF2 | CeF3, CeOF, SmF2 | 8.9 | 15.4 | 18.7 | 0.59 |
| Sm₂Co₁₇ | CeF2 | CeF3, CeOF, SmF2, | 9.3 | 15.8 | 19.5 | 0.58 |
| | | Co | | | | |
| Sm₂Co₁₇ | CeF3 | CeF2, CeOF, SmF2 | 9.4 | 16.2 | 19.7 | 0.57 |
| Sm₂Co₁₇ | CeF3 | CeF2, CeOF, SmF2, | 9.3 | 16.1 | 19.5 | 0.56 |
| | | Co | | | | |
| Sm₂Co₁₇ | PrF2 | PrF3, PrOF, SmF2 | 8.8 | 16.5 | 18.5 | 0.58 |
| Sm₂Co₁₇ | PrF2 | PrF3, PrOF, SmF2, | 9.1 | 16.8 | 19.1 | 0.57 |
| | | Co | | | | |
| Sm₂Co₁₇ | PrF3 | PrF2, PrOF, SmF2 | 9.2 | 17.4 | 19.3 | 0.58 |
| Sm₂Co₁₇ | PrF3 | PrF2, PrOF, SmF2, | 9.2 | 17.2 | 19.3 | 0.57 |
| | | Co | | | | |
| Sm₂Co₁₇ | NdF2 | NdF3, SmOF | 8.7 | 16.3 | 18.3 | 0.58 |
| Sm₂Co₁₇ | NdF2 | NdF3, SmOF, Co | 8.9 | 16.1 | 18.7 | 0.56 |
| Sm₂Co₁₇ | NdF3 | NdF2, SmOF | 9.0 | 15.4 | 18.9 | 0.55 |
| Sm₂Co₁₇ | NdF3 | NdF2, SmOF, Co | 9.2 | 15.2 | 19.3 | 0.54 |
| Sm₂Co₁₇ | SmF3 | SmF2, SmF2, SmOF | 8.7 | 14.2 | 18.3 | 0.58 |
| Sm₂Co₁₇ | SmF3 | SmF2, SmF2, SmOF, | 9.1 | 13.9 | 19.1 | 0.56 |
| | | Co | | | | |
| Sm₂Co₁₇ | EuF3 | EuF2, EuF2.55, | 8.8 | 13.8 | 18.5 | 0.57 |
| | | SmF2, SmOF | | | | |
| Sm₂Co₁₇ | EuF3 | EuF2, EuF2.55, | 9.0 | 14.9 | 18.9 | 0.55 |
| | | SmF2, SmOF, Co | | | | |
| Sm₂Co₁₇ | GdF3 | GdF2, SmF2, SmOF | 8.5 | 15.5 | 17.9 | 0.56 |
| Sm₂Co₁₇ | GdF3 | GdF2, SmF2, SmOF, | 8.9 | 15.1 | 18.7 | 0.55 |
| | | Co | | | | |
| Sm₂Co₁₇ | TbF3 | TbF2, SmF2, SmO2 | 8.6 | 17.9 | 18.1 | 0.57 |
| Sm₂Co₁₇ | TbF3 | TbF2, SmF2, SmO2, | 8.9 | 18.1 | 18.7 | 0.55 |
| | | Co | | | | |
| Sm₂Co₁₇ | DyF3 | DyF2, SmF2, SmO2 | 7.8 | 18.5 | 16.4 | 0.58 |
| Sm₂Co₁₇ | DyF3 | DyF2, SmF2, SmO2, | 8.5 | 18.4 | 17.9 | 0.55 |
| | | Co | | | | |
| Sm₂Co₁₇ | HoF3 | HoOF, SmO2 | 7.9 | 15.5 | 16.6 | 0.59 |
| Sm₂Co₁₇ | HoF3 | HoOF, SmO2, Co | 8.2 | 15.3 | 17.2 | 0.56 |
| Sm₂Co₁₇ | ErF3 | SmF2, SmF2 | 7.6 | 13.2 | 16.0 | 0.57 |
| Sm₂Co₁₇ | ErF3 | SmF3, SmF2, Co | 7.9 | 13.5 | 16.6 | 0.54 |
| Sm₂Co₁₇ | TmF3 | TmF2, SmF3, SmF2 | 8.1 | 13.0 | 17.0 | 0.56 |
| Sm₂Co₁₇ | TmF3 | TmF2, SmF3, SmF2, | 8.5 | 13.2 | 17.9 | 0.55 |
| | | Co | | | | |
| Sm₂Co₁₇ | YbF2 | YbF2.37, SmOF, | 8.6 | 12.8 | 18.1 | 0.56 |
| | | SmF2 | | | | |
| Sm₂Co₁₇ | YbF2 | YbF2.37, SmOF, | 8.8 | 12.9 | 18.5 | 0.55 |
| | | SmF2, Co | | | | |
| Sm₂Co₁₇ | LuF3 | SmF2, SmF3 | 7.9 | 12.7 | 16.6 | 0.57 |

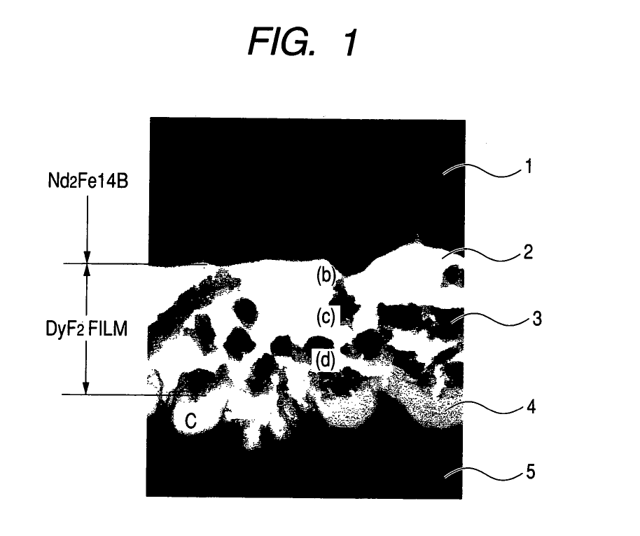

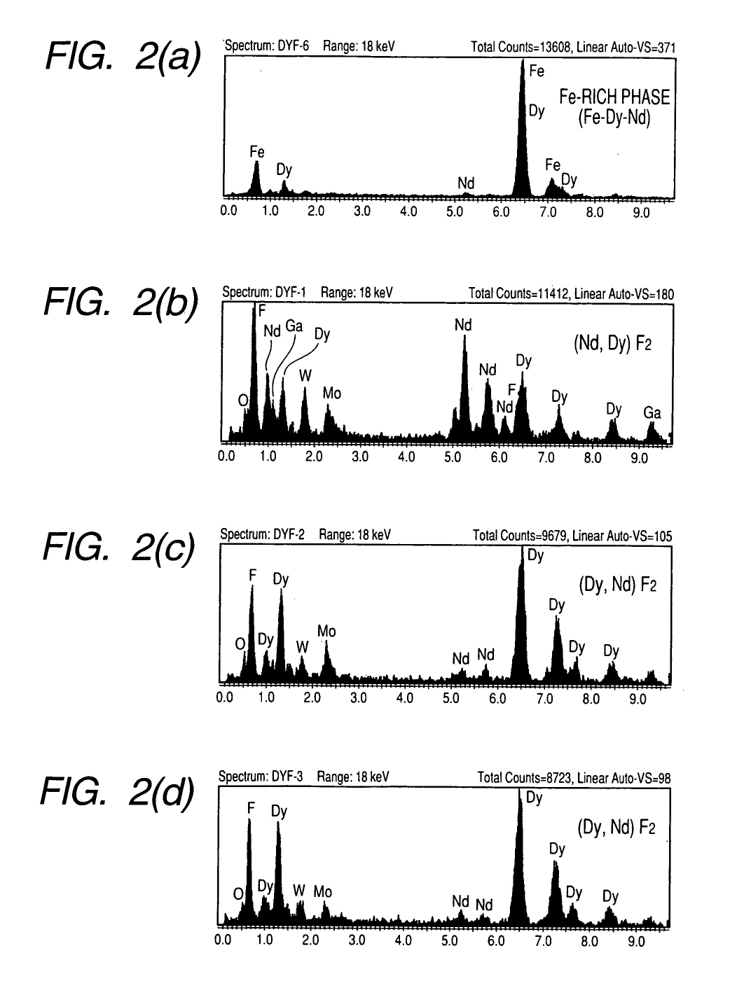

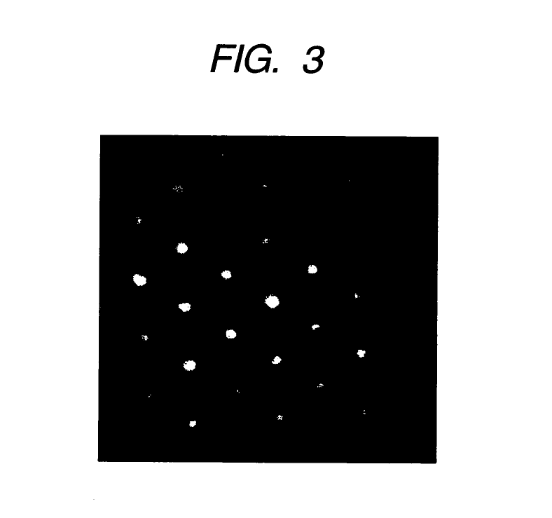

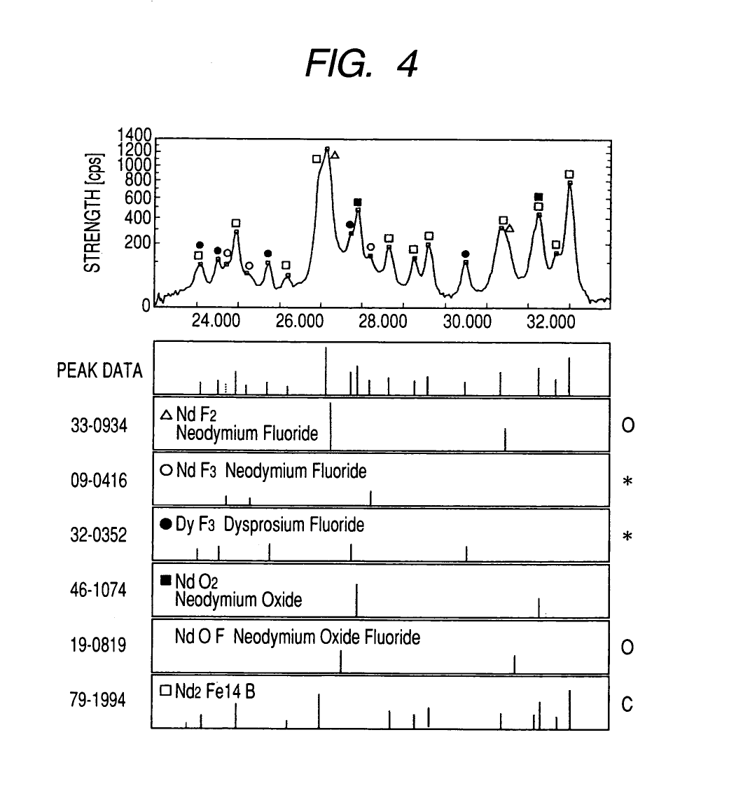

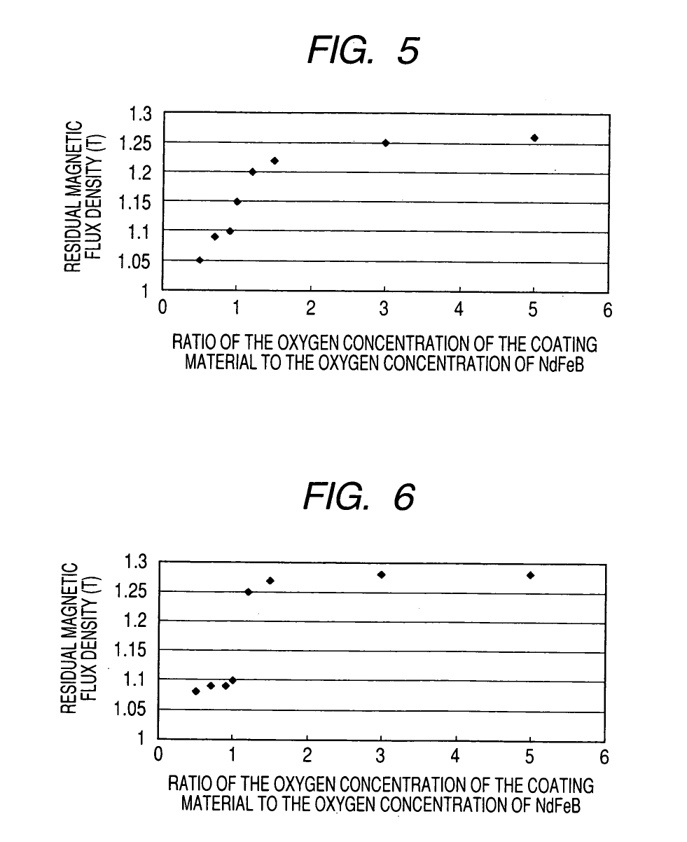

FIG. 5 shows the ratio of the oxygen concentration of the formed fluorine compound to the oxygen concentration on the magnetic particle surface as the ratio of the oxygen concentration of the coating material to the oxygen concentration of NdFeB, and also shows the relation between the ratio of the oxygen concentration mentioned above and the residual magnetic flux density. The higher the residual magnetic flux density is, the higher the maximum energy product is. When the ratio of the oxygen concentration of the coating material to the oxygen concentration of NdFeB becomes near 1, however, the residual magnetic flux density changes. When the ratio exceeds 2, the change is lessened. This means that the residual magnetic flux density can be increased by setting the ratio of the oxygen concentration of the coating material to the oxygen concentration of NdFeB to more than 1. That is, when the oxygen concentration in the fluorine compound is higher than the oxygen concentration on the NdFeB powder surface, the residual magnetic flux density can be made higher than when the fluorine compound is not formed on the magnetic particle. Heat treatment was performed for rare earth magnet magnetic particles on which to form DyF₃ coating films for one hour at 800° C., which is enough to increase the residual magnetic flux density. The evaluation result for the cross section of the powder will be described below. To investigate the crystalline structure and composition (transmission electron microscopy-energy dispersive X-ray spectrometry (TEM-EDX) is used) through a transmission electron microscope (TEM), a cross-section sample was prepared by using the focused ion beam (FIB) technique. After powder was processed by Ga ions, it was placed on a Mo mesh for the TEM and observation was carried out through the TEM. The acceleration voltage for the TEM was 200 kV. FIG. 1 shows a TEM image taken near the fluorine compound. In FIG. 1, the NdFeB parent phase 1 is Nd₂Fe₁₄B, on the surface of which a Dy fluorine compound is formed. Part of the Dy fluorine compound layer is a void 2 which was formed to prepare the sample and a fluorine compound particle 3. On the outer side thereof are a carbon protection layer 4 for sample protection and observation purposes and a tungsten protection layer 5. The crystal grain size of the Dy fluorine compound is 10 to 200 nm; the size can be varied depending on the liquid to be applied and the application condition. The crystallinity and orientation of the fluorine compound can also change depending on the liquid to be applied, the application condition, and the structure of the surface of the NdFeB magnetic particle. The compositions at (a), (b), (c), and (d) in FIG. 1 were analyzed. FIGS. 2A, 2B, 2C, and 2D show the results. The diameters in the range analyzed are about 10 to 100 nm. FIG. 2A shows the composition on the NdFeB magnetic particle side; the composition is Fe-rich, so the rare earth element concentration is lower than the rare earth element concentration in the fluorine compound layer, and the oxygen concentration is also lower than the oxygen concentration in the fluorine compound layer. Thus, near the surface of the NdFeB magnetic particle, there is a layer that has a low oxygen concentration and includes much Fe, the value of magnetization of which is higher when compared with other layers. It is possible to allow this Fe-rich layer to have a high saturated magnetic flux density and to increase the residual magnetic flux density by exchange coupling to another layer having strong magnetism. FIG. 2B shows an analysis result of the Dy fluorine compound layer; there is a high fluorine peak. Dy and Nd appear, indicating that the fluorine compound includes Nd and Dy. In FIGS. 2C and 2D, Nd and Dy rare earth elements appear besides fluorine, as in FIG. 2B; oxygen was also detected. Thus, the rare earth element concentrations are higher in the fluorine compound than in the Fe layer on the magnetic particle surface. This may because part of the rare earth elements in the NdFeB magnetic particle diffuses into the fluorine compound and thus the rare earth element concentration in the fluorine compound is increased. Part of the oxygen in the magnetic particles also diffuses into the fluorine compound, so the oxygen concentration in the fluorine compound is higher than the oxygen concentration on the magnetic particle surface. The composition analysis results in FIGS. 2C and 2D indicate that the ratio of Dy to fluorine is about 1:2. FIG. 3 shows an electron diffraction image of the portions at (c) and (d). This electron diffraction image is known to match <110>that is the same crystalline structure as in NdF₂ and to be a face-centered cubic lattice (fcc). From the composition analysis results, the image can be identified as DyF₂ having an fcc structure. FIG. 4 shows the measurement result of XRD patterns of the magnetic particle on which the Dy fluorine compound is formed. In this measurement, the average diameter of the magnetic particles is about 200μm. The diffraction patterns are thought to include information within about 10 μm of the magnetic particle surface. NdF₂, NdF₃, and DyF₃ could be identified as rare earth fluorine compounds. Of these, NdF₂ is assumed to be a compound in which Nd is included in DyF₂, which is a fluorine compound of Dy. It was also confirmed that NdFO was formed as an oxygen-fluorine compound, indicating that oxygen is included in the fluorine compound. A small amount of NdO₂ was also detected, leading to an assumption that part of a phase including large amounts of rare earth elements was oxidized. In the case of the SmCo magnetic particle, a Co phase is formed rather than the Fe-rich phase. As the result of the formation of a Co phase, the residual magnetic flux density tends to increase as in the case in which a Fe-rich phase appears in NdFeB. When heat treatment is carried out at 500° C. or higher so that the residual magnetic flux density is increased, a fluorine compound or oxygen-fluorine compound with an fcc structure is formed as described above, the lattice constant being 0.54 to 0.60 nm as indicated in Table 1. The lattice constant of the same value is also obtained for a fluorine compound applied to a SmCo magnetic particle. To increase the residual magnetic flux density, a Co phase (a CoFe phase is also acceptable) is formed; as the oxygen concentration in the fluorine compound increases, the energy product also tends to increase. When the magnetic particle on which the above fluorine compound is formed is mixed with organic resin such as epoxy resin, polyimide resin, polyamide resin, polyamide-imide resin, kelimide resin, maleimide resin, polyphenylether, or polyphenylene sulfide, or with organic resin of epoxy resin, polyamide resin, polyamide-imide resin, kelimide resin, maleimide resin, or the like so as to form a compound. The compound can be then molded into a bond magnet in a magnetic field or a non-magnetic field.

[Third Embodiment]

Treatment liquid for forming neodymium (Nd) fluorine compound coating films was prepared as follows:

(1) Four grams of Nd acetate or Nd nitrate, which is salt with high solubility, was added to 100 mL of water. The salt was completely dissolved by using a shaker or ultrasonic agitator.

(2) Hydrofluoric acid diluted to about 10% was gradually added by an equivalent for a chemical reaction by which NdF₃ is created.

(3) The solution in which gelled NdF₃ was precipitated was agitated by an ultrasonic agitator for one hour or more.

(4) Centrifugal separation was performed at a rotational speed of 4000 rpm. Then supernatant fluid was removed and methanol was added by almost the same amount.

(5) The methanol solution including gelled NdF₃ was agitated to form a complete suspension. The suspension was agitated by an ultrasonic agitator for one hour or more.

(6) Operation in (4) and (5) was repeated 4 times until negative ions such as acetate ions or nitrate ions were no longer detected.

(7) Slightly suspended, sol-state NdF₃ was obtained. A methanol solution including NdF₃ with a concentration of 1 g/15 mL was used as the treatment liquid.

Next, NdFeB alloy powder or SmCo alloy powder was used as rare earth magnet magnetic particles. The rare earth magnet magnetic particles in this alloys have an average particle diameter of 100 μm and magnetically anisotropic. Processes for forming rare earth fluorine compound coating films or alkaline earth metal fluorine compound coating films on rare earth magnet magnetic particles were practiced by the procedure below

(1) When the average particle diameter is 100 μm, 10 mL of NdF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which NdF₃ coating films were formed, were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C for 30 minutes, under a reduced pressure of 1×10⁻⁵ torr.

(4) The magnetic particles, for which heat treatment was performed in (3), were moved to a container with a cover, and then heated at 400° C. to 800° C. under a reduced pressure of 1×10⁻⁵ torr.

(5) The magnetic properties of the rare earth magnet magnetic particles, for which heat treatment were performed in (4), were investigated.

The measurement results of magnetic properties are shown according to Table 1.

When NdF₃ was formed on the surface of the NdFeB powder as described above, heat treatment was performed for 30 minutes to 1 hour at 400° C. so as to have NdF₂ and NdOF develop near the interface. If the heat treatment is further continued at higher temperatures of 500° C. to 800° C., a Fe phase develops on other than the above interface. This type of Fe phase includes a rare earth element, but the oxygen concentration is higher on the fluorine compound side than on the magnetic particle surface. When another fluorine compound is formed by surface treatment, a Fe phase having an oxygen concentration lower than the oxygen concentration in the fluorine compound also develops only at a heat treatment temperature of higher than 400° C. When the heat treatment is performed at a high temperature as described above, rare earth elements, oxygen, and the like diffuse between the fluorine compound and the magnetic particle, part of the oxygen in the magnetic particle diffuses into the fluorine compound, and part of the rare earth elements in the magnetic particle diffuses into the fluorine compound. This diffusion causes the Fe phase (Fe rare earth alloy) to develop on the magnetic particle surface, and part of it is exchange-coupled to NdFeB in the parent phase. Since the Fe phase has a higher saturated magnetic flux density than NdFeB, exchange-coupling to NdFeB makes the magnetization rotation of Fe difficult for an external magnetic field, increasing the residual magnetic flux density and thereby increasing the maximum energy product BHmax. FIG. 6 shows the ratio of the oxygen concentration of the formed neodymium fluorine compound to the oxygen concentration on the magnetic particle surface as the ratio of the oxygen concentration of the coating material to the oxygen concentration of NdFeB, and also shows the relation between the ratio mentioned above and the residual magnetic flux density. The higher the residual magnetic flux density is, the higher the maximum energy product is. When the ratio of the oxygen concentration of the coating material to the oxygen concentration of NdFeB becomes near 1, however, the residual magnetic flux density changes. When the ratio exceeds 2, the change is lessened. This means that the residual magnetic flux density can be increased by setting the ratio of the oxygen concentration of the coating material to the oxygen concentration of NdFeB to more than 1. That is, when the oxygen concentration in the neodymium fluorine compound is higher than the oxygen concentration on the NdFeB powder surface, the residual magnetic flux density can be made higher than when the fluorine compound is not formed on the magnetic particle.

[Fourth Embodiment]

Treatment liquid for forming neodymium fluorine compound coating films was prepared as described above; a methanol solution including NdF₃ with a concentration of 1 g/20 mL was prepared, and NdFeB alloy powder or SmCo alloy powder was used as rare earth magnet magnetic particles. The rare earth magnet magnetic particles have an average particle diameter of 5 μm and magnetically anisotropic. Processes for forming rare earth fluorine compound coating films or alkaline earth metal fluorine compound coating films on rare earth magnet magnetic particles were practiced by the procedure below

(1) When the average particle diameter is 5 μm, 20 mL of NdF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which NdF₃ coating films were formed, were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were inserted to a metal mold, and then press molding was performed in a magnetic field. For easy magnetic orientation, an organic substance may be added before molding.

(5) The press-molded product for which magnetic orientation was conducted was sintered at temperatures of 800° C. to 1100° C. in a vacuum (under a degree of vacuum of 1×10⁻³ torr or lower), in an inert gas such as Ar gas, or in a deoxidation atmosphere including, for example, Ar+5%H_{2.}

(6) The sintered sample is a cube measuring 10 mm ×10 mm ×10 mm. A magnetizing magnetic field was applied in the direction of anisotropy, and magnetic properties were evaluated.

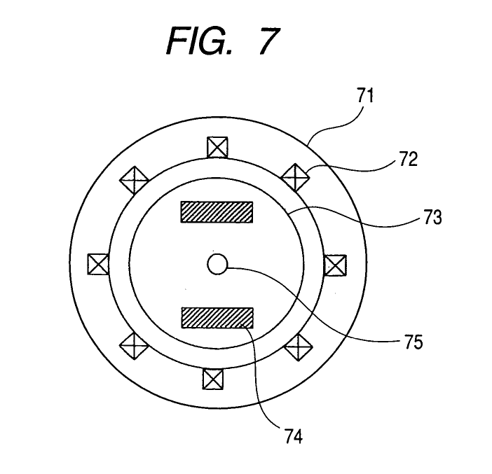

This sintered magnet exhibited the following properties: the resistivity is 0.5 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. The above-mentioned resistivity is 3 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation is suppressed, the thermal decay of the magnet can be lessened. The present invention can be applied not only to motors but also to general rotating machines including power generators in which permanent magnets are used. FIG. 7 shows an example in which the present invention is applied to a rotating machine. Reference numerals 71, 72, 73, 75, and 74 indicate a stator, a coil, a rotor, a rotating axis, and the magnet described in the above embodiments, respectively.

[Fifth Embodiment]

Treatment liquid for forming terbium fluorine compound coating films was prepared as described above; a methanol solution including TbF₃ with a concentration of 1 g/20 mL was prepared, and NdFeB alloy powder or SmCo alloy powder was used as rare earth magnet magnetic particles. The magnetic particles have an average particle diameter of 5 μm and are magnetically anisotropic. That is, the magnetic particles can be oriented in an anisotropic direction by an external magnetic field. This embodiment was practiced by using processes for forming rare earth fluorine compound coating films or alkaline earth metal fluorine compound coating films on rare earth magnet magnetic particles as described below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which TbF₃ coating films were formed, were placed under a reduced pressure of 2 to 5 torr to remove the methanol solvent.

(3) The rare earth magnet magnetic particles from which the solvent was removed in (2) was moved to a ceramic board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. For easy magnetic orientation, an organic substance may be added before molding. Uncoated powder and the above coated powder may be alternately laminated so that the uncoated powder and the coated powder can be sintered under the same heat treatment condition. In this case, part of the coated powder becomes highly resistive, so, in a resulting sintered body, the electric resistance in the press direction is higher than the electric resistance of an uncoated sintered body on the pressed surface.

(5) The press-molded product, for which magnetic orientation was conducted, was sintered at temperatures of 500° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm×10 mm×10 mm. A magnetizing magnetic field was applied in an anisotropic direction, and magnetic properties were evaluated.

This sintered magnet exhibited the following properties: the resistivity is 0.3 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. On a part in contact with the fluorine compound on the surface of the NdFeB powder, fluorine diffuses into the frontmost surface of the NdFeB powder as well. Since oxygen is present in the fluorine compound, an oxygen-fluorine compound is also formed. The oxygen-fluorine compound is more brittle and easier to peel than the fluorine compound, so the growth of the oxygen-fluorine compound should be suppressed to increase the density of the formed body. The above-mentioned resistivity is 2 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation from the magnet is suppressed, the thermal decay of the magnet can be lessened.

[Sixth Embodiment]

Treatment liquid for forming terbium fluorine compound coating films was prepared as described above; a methanol solution including TbF₃ with a concentration of 2 g/20 mL was prepared, and NdFeB alloy powder or SmCo alloy powder was used as rare earth magnet magnetic particles. The magnetic particles have an average particle diameter of 5 to 20 Am and are magnetically anisotropic. The processes in this embodiment are similar to the processes for forming rare earth fluorine compound coating films or alkaline earth metal fluorine compound coating films on rare earth magnet magnetic particles, so this embodiment was practiced as described below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted. Another fluorine compound treatment liquid, such as, for example, TbF₃+NdF₃ or DyF₃+NdF₃, may be added during mixing.

(2) The rare earth magnet magnetic particles, on which TbF₃ coating films were formed, or the magnetic particles coated with a plurality of types of fluorine compound forming liquids, which were obtained in (1), were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. For easy magnetic orientation, an organic substance may be added before molding. Uncoated powder and the above coated powder may be alternately laminated so that the uncoated powder and the coated powder can be sintered under the same heat treatment condition. In this case, part of the coated powder becomes highly resistive, so, in a resulting sintered body, the electric resistance in the press direction is higher than the electric resistance of an uncoated sintered body on the pressed surface. Alternatively, a laminate of highly resistive layers can be formed by placing fluorine compound powder on a temporarily molded body of uncoated powder in such a way that an average thickness of 0.1 to 1000 μm is obtained, performing temporary molding, placing uncoated powder on the resulting temporarily molded body, and performing molding.

(5) The press-molded product, for which magnetic orientation was conducted, was sintered at temperatures of 800° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm ×10 mm ×10 mm. A magnetizing magnetic field was applied in an anisotropic direction, and magnetic properties were evaluated.

This sintered magnet exhibited the following properties: the resistivity is 0.3 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. As a result, a compound such as REnFm or Ren(F, O)m is formed, where RE is a rare earth element, F is fluorine, O is oxygen, and n and m are integers. The above-mentioned resistivity is 2 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation from the magnet is suppressed, the thermal decay of the magnet can be lessened.

[Seventh Embodiment]

Treatment liquid for forming terbium fluorine compound coating films was prepared as described above; a methanol solution including TbF₃ with a concentration of 2 g/20 mL was prepared, and NdFeB alloy powder or SmCo alloy powder was used as rare earth magnet magnetic particles. The magnetic particles have an average particle diameter of 5 to 20 μm and are magnetically anisotropic. Processes for forming rare earth fluorine compound coating films or alkaline earth metal fluorine compound coating films on rare earth magnet magnetic particles were practiced as described below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted. Another fluorine compound powder, such as, for example, a rare earth nitrogen compound or rare earth carbon compound, may be added during mixing. The compound powder remains as a nitrogen compound even after sintering. Since part of rare earth elements diffuses into magnetic particles, the magnetic properties can be improved. Particularly, when nitrogen compounds of Dy or Tb are present in the fluorine compound film, not only the resistance is increased but also the angularity of a magnetization curve is improved and the coercive force is increased.

(2) The rare earth magnet magnetic particles, on which TbF₃ coating films were formed, or magnetic particles coated with a fluorine compound forming liquid mixed with rare earth nitrogen compound powder, which were obtained in (1), were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. For easy magnetic orientation, an organic substance may be added before molding. Uncoated powder and powder mixed with the above nitrogen compound may be alternately laminated by performing temporary molding a plurality of times so that the uncoated powder and the coated powder can be sintered under the same heat treatment condition. In this case, part of the coated powder becomes highly resistive, so, in a resulting sintered body, the electric resistance in the press direction is higher than the electric resistance of an uncoated sintered body on the pressed surface.

(5) The press-molded product, for which magnetic orientation was conducted, was sintered at temperatures of 500° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm ×10 mm ×10 mm. A magnetizing magnetic field was applied in an anisotropic direction, and magnetic properties were evaluated.

This sintered magnet exhibited the following properties: the resistivity is 0.3 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. The above-mentioned resistivity is 2 to 100 times higher as compared with the conventional sintered NdFeB magnet, which can suppress eddy current from flowing in the magnet and reduce loss in the magnet part. If a growth of a fluorine compound, oxygen-fluorine compound, nitrogen compound, or carbide of Tb or Dy is found in the highly resistive layer, Tb or Dy diffuses on the magnetic particle surface, increasing the magnetic anisotropy. Resulting effects include improvements in coercive force, magnetization curve angularity, and magnetization as well as reduction in thermal demagnetization. These effects in the improvement of the magnetic properties are recognized by mixing a rare earth nitrogen compound or rare earth carbon compound with NdFeB alloy powder or SmCo alloy powder and performing sintering to cause rare earth elements to diffuse into the surfaces of magnetic particles. Accordingly, due to these material processes, when the inventive magnet is used in a motor in which a high-frequency magnetic field is applied to the magnet part, such as a multi-pole motor, a high-frequency motor, or a high-speed motor, or in a circuit in magnetic resonance imaging (MRI.) or the like, the loss in the magnet part can be lessened by these material processes. Since this provides the same effect as when heat generation from the magnet is suppressed, the thermal decay of the magnet can be lessened.

[Eighth Embodiment]

Treatment liquid for forming terbium fluorine compound coating films was prepared as described above; a methanol solution including TbF₃ with a concentration of 2 g/20 mL was prepared, and NdFeB alloy powder or SmCo alloy powder was used as rare earth magnet magnetic particles. The magnetic particles have an average particle diameter of 5 to 20 μm and are magnetically anisotropic. Processes for forming rare earth fluorine compound coating films or alkaline earth metal fluorine compound coating films on rare earth magnet magnetic particles were practiced as described below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted. Another fluorine compound treatment liquid, such as, for example, TbF₃+NdF₃ or DyF₃+NdF₃, may be added during mixing.

(2) The rare earth magnet magnetic particles, on which TbF₃ coating films were formed, or magnetic particles coated with a plurality of types of fluorine compound forming liquids, which were obtained in (1), were placed under a reduced pressure of 2 to 5 torr to remove the methanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field with an intensity of 0.5 kOe or more. For easy magnetic orientation, an organic substance may be added before molding. Uncoated powder and the above coated powder may be alternately laminated so that the uncoated powder and the coated powder can be sintered under the same heat treatment condition. In this case, part of the coated powder becomes highly resistive, so, in a resulting sintered body, the an electric resistance in the press direction is higher than the electric resistance of an uncoated sintered body on the pressed surface. At this time, rare earth nitrogen compounds with a particle diameter of 1 μm or less may be mixed in the coating liquid of coated powder. When chemical symbols are used, a rare earth nitrogen compound is represented as REN (RE is a rare earth element). A plurality of rare earth elements may be mixed. Mixed rare earth nitrogen compounds include LaN, CeN, PrN, NdN, SmN, EuN, GdN, TbN, DyN, HoN, ErN, TbN, and LuN. Other nitrogen compounds that can be mixed in fluoride coating films are AIN, YN, HfN, TaN, ZrN, TiN, and VN.

(5) The press-molded product, for which magnetic orientation was conducted, was dipped again into the coating liquid so as to coat spacings among magnetic particles or the surfaces of cracks. When the press pressure is increased step by step and the pres-molded product is dipped into the coating liquid each time the pressure is increased, the resistance can be increased. Then, the press-molded product was sintered at temperatures of 800° C. to 1100° C. in a vacuum (under a degree of vacuum of 1×10⁻³ torr or lower), in an inert gas such as Ar gas, or in a reduction atmosphere including, for example, Ar+5%H2. Although sintering is also possible at temperatures of 500° C. to 800° C., the density of the sintered body is lowered to 80% to 96%. When a high energy product is desirable, therefore, preferable temperatures are 800° C. or higher.

(6) The sintered sample is a cube measuring 10 mm ×10 mm ×10 mm. A magnetizing magnetic field was applied in an anisotropic direction, and magnetic properties were evaluated.

This sintered magnet exhibited the following properties: the resistivity is 0.3 to 15 m Ω-cm, the residual magnetic flux density is 1.0 to 1.2 T, and the maximum energy product is 25 to 40 MGOe. Sintering proceeds while diffusion coupling of part of the fluorine compounds or rare earth elements is being carried out. The above processes causes fluorine to diffuse into part of the surface of the magnetic particle, increasing the electric resistance of the surface. The above-mentioned resistivity is 2 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation from the magnet is suppressed, the thermal decay of the magnet can be lessened.

[Ninth Embodiment]

Treatment liquid for forming terbium fluorine compound coating films was prepared; a methanol solution including TbF₃ with a concentration of 1 g/20 mL was prepared, and NdFeB alloy powder or SmCo alloy powder was used as rare earth magnet magnetic particles. The magnetic particles have an average particle diameter of 5 μm. It is magnetically anisotropic and amorphous. That is, the magnetic particles can be oriented in an anisotropic direction by an external magnetic field. Coating processes are outlined below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which TbF₃ coating films were formed, were placed under a reduced pressure of 2 to 5 torr to remove the methanol solvent.

(3) The rare earth magnet magnetic particles from which the solvent was removed in (2) was moved to a ceramic board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. For easy magnetic orientation, an organic substance may be added before molding. Temporary molding is performed for uncoated powder in a magnetic field, and then coated powder is supplied onto the resulting layer and temporary molding is performed in a magnetic field. Uncoated powder is further supplied and temporary molding is performed. When this process is repeated so that uncoated powder and coated powder are alternately laminated, the uncoated powder and the coated powder can be sintered under the same heat treatment condition. In this case, part of the coated powder becomes highly resistive, so, in a resulting sintered body, the electric resistance in the press direction is higher than the electric resistance of an uncoated sintered body on the pressed surface.

(5) The press-molded product, for which magnetic orientation was conducted, was sintered at temperatures of 500° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm ×10 mm ×10 mm. A magnetizing magnetic field was applied in an anisotropic direction, and magnetic properties were evaluated.

This sintered magnet exhibited the following properties: the resistivity is 0.2 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. On a part in contact with the fluorine compound on the surface of the NdFeB powder, fluorine diffuses into the frontmost surface of the NdFeB powder as well. Since oxygen is present in the fluorine compound, an oxygen-fluorine compound is also formed. The oxygen-fluorine compound is more brittle and easier to peel than the fluorine compound, so the growth of the oxygen-fluorine compound should be suppressed to increase the density of the formed body. This type of surface treatment by use of a fluorine compound can be applied to not only magnetic particles but also surfaces of a bulk magnet. The resistivity of the sintered magnet fabricated by performing heat treatment for the above magnetic particles is 2 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation from the magnet is suppressed, the thermal decay of the magnet can be lessened.

[Tenth Embodiment]

Treatment liquid for forming neodymium fluorine compound coating films was prepared; a methanol solution including NdF₃ with a concentration of 1 g/20 mL was prepared, and NdFeB alloy powder or SmCo alloy powder was used as rare earth magnet magnetic particles. The magnetic particles have an average particle diameter of 5 to 100 μm. It is magnetically anisotropic and amorphous. That is, the magnetic particles can be oriented in an anisotropic direction by an external magnetic field. Coating processes are outlined below.

(1) When the average particle diameter was 5 μm, 20 mL of NdF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which NdF₃ coating films were formed, were placed under a reduced pressure of 2 to 5 torr to remove the methanol solvent.

(3) The rare earth magnet magnetic particles from which the solvent was removed in (2) was moved to a ceramic board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. For easy magnetic orientation, an organic substance may be added before molding. Temporary molding is performed for uncoated powder in a magnetic field, and then coated powder is supplied onto the resulting layer and temporary molding is performed in a magnetic field. Uncoated powder is further supplied and temporary molding is performed. When this process is repeated so that uncoated powder and coated powder are alternately laminated, the uncoated powder and the coated powder can be sintered under the same heat treatment condition. In this case, part of the coated powder becomes highly resistive, so, in a resulting sintered body, the electric resistance in the press direction is higher than the electric resistance of an uncoated sintered body on the pressed surface.

(5) The press-molded product, for which magnetic orientation was conducted, was sintered at temperatures of 500° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm ×10 mm ×10 mm. A magnetizing magnetic field was applied in an anisotropic direction, and magnetic properties were evaluated.

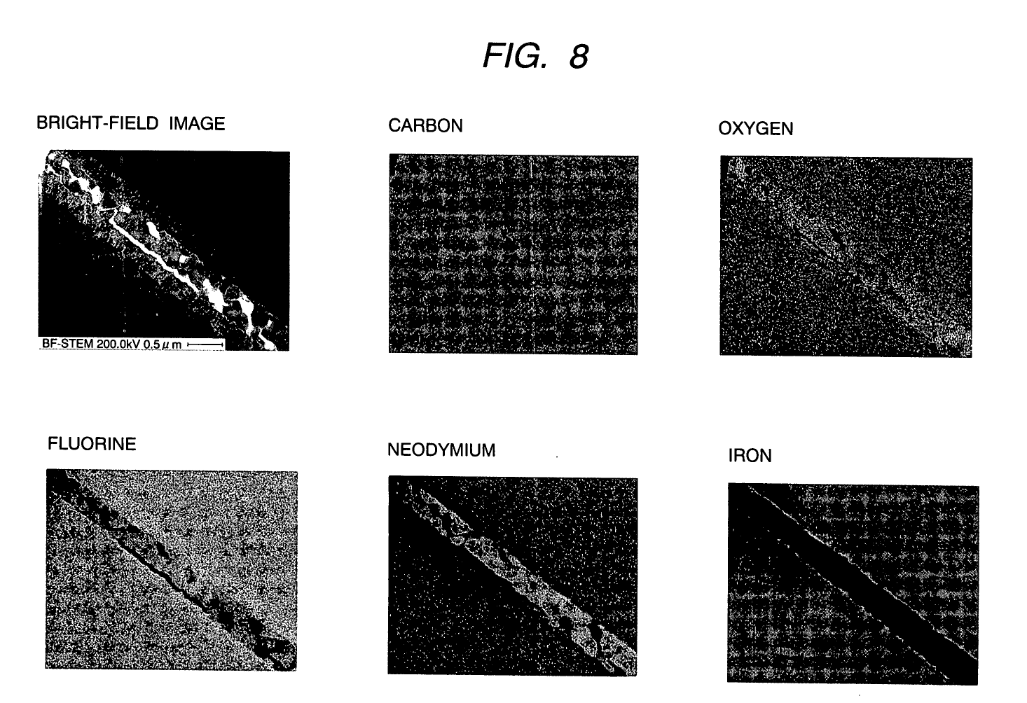

This sintered magnet exhibited the following properties: the resistivity is 0.2 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. FIG. 8 shows cross sections of sintered bodies, which were observed with an electron microscope. NdF₂ or NdF₃ is formed on the surface of each NdFeB magnetic particle. Crystal grains that mainly consist of fluorine compounds develop among magnetic particles. The size of a crystal grain that mainly consists of fluorine compounds is 50 to 200 nm. The drawing shows that fluorine compounds formed on the surface of a magnetic particle develop due to sintering and fluorine compounds are combined among magnetic particles. Sintering of these fluorine compounds proceeds even at 500° C., indicating that low-temperature sintering is possible. White consecutive parts in a bright-field image are holes which were formed by irradiation with ions during preparation of a transmission electron microscopy (TEM) sample. The drawing also shows element analysis images of carbon, oxygen, fluorine, neodymium, and iron at the same position as the bright-field image. Fluorine compounds are formed along the surface of the magnetic particle. Much oxygen and neodymium are present in that portion. Much oxygen is present in a portion that mainly consists of fluorine compounds, indicating that the oxygen concentration in the portion is higher than that in the magnetic particle. Carbon is present in part of the fluorine compound. Accordingly, it is assumed that oxygen or carbon is included in a crystal grain that mainly consists of fluorine compounds and thus oxygen-fluorine compounds such as Nd(F, O)₂ or Nd(F, O)₂, carbon-fluorine compounds, or fluorine compounds including oxygen and carbon are formed. With attention focused on a fluorine distribution, it is found that fluorine segregates in the fluorine compounds outside the magnetic particle and on the frontmost surface within the magnetic particle. As a result, fluorine atoms in the fluorine compounds formed outside the magnetic particle diffuse into the magnetic particle in the sintering process and are detected at a thickness of up to about 300 nm. On a part in contact with the fluorine compound on the surface of the NdFeB powder, fluorine diffuses into the frontmost surface of the NdFeB powder as well. Since oxygen is present in the fluorine compound, an oxygen-fluorine compound is also formed. The oxygen-fluorine compound is more brittle and easier to peel than the fluorine compound, so the growth of the oxygen-fluorine compound should be suppressed to increase the density of the formed body. The above-mentioned resistivity is 2 to 100 times higher as compared with the conventional sintered NdFeB magnet; the resistance of the magnetic particle is increased by the oxygen-fluorine compound, the carbon-fluorine compound, or the fluorine-containing layer on the magnetic particle surface, which can suppress eddy current from flowing in the magnet and reduce loss in the magnet part. This type of fluorine compounds can be formed by a method in which surface treatment is performed for magnetic particles in advance to form fluorine compounds and then temporary molding and sintering are performed. Another method of forming the fluorine compounds is to have treatment liquid penetrate into spacings among magnetic particles after the magnetic particles are temporarily molded. An optimum method should be selected according to the shape, size, and other factors of the magnetic particle. Alternatively, both methods may be combined. In particular, the fluorine-containing layer on the magnetic particle surface is considered to contribute to increasing the resistance and corrosion resistance. The atomic position of the fluorine atom in the fluorine-containing layer is unclear, but it is assumed that the fluorine atom is positioned near a rare earth element as part of a Nd₂Fe₁₄(B, F) compound.

[Eleventh Embodiment]

Treatment liquid for forming terbium fluorine compound coating films was prepared; a methanol solution including TbF₃ with a concentration of 1 g/20 mL was prepared, and NdFeB alloy powder or SmCo alloy powder was used as rare earth magnet magnetic particles. The magnetic particles have an average particle diameter of 5 to 10 μm. It is magnetically anisotropic and amorphous. That is, the magnetic particles can be oriented in an anisotropic direction by an external magnetic field. Coating processes are outlined below.

(1) When the average particle diameter was 5 μm, 20 mL of TbF₃ coating film forming treatment liquid was added to 100 g of rare earth magnet magnetic particles. Mixing was performed until it was confirmed that the entire rare earth magnet magnetic particles were wetted.

(2) The rare earth magnet magnetic particles, obtained in (1), on which TbF₃ coating films were formed, were placed under a reduced pressure of 2 to 5 torr to remove the methanol solvent.

(3) The rare earth magnet magnetic particles from which the solvent was removed in (2) was moved to a ceramic board, and then heated at 200° C. for 30 minutes and at 400° C. for 30 minutes, under a reduced pressure of 1×10⁻⁵ torr.

(4) The magnetic particles, for which heat treatment was performed in (3), were inserted into a metal mold, and then press molding was performed in a magnetic field. There are surfaces on which coating films are not developed due to cracks generated in magnetic particles during press molding. When these non-coated surfaces are brought into contact with each other, the resistance is decreased. To prevent this, coating film forming treatment liquid with low viscosity is supplied into the metal mold so that coating films are also formed on the surfaces of the above-mentioned cracks. Accordingly, even if cracks or non-coated surfaces appear during a pressing process, coating films are formed on these surfaces, increasing the resistance of the molded body. It is also possible to magnetically orient the magnetic particles in the coating liquid before the pressing process. Even if coating films are not formed on the surfaces of the magnetic particles in advance, therefore, when magnetic orientation in the coating liquid and molding are performed as described above, magnetic particle surfaces including cracks can be made highly resistive. The magnetic field may be an AC magnetic field; its strength is 1 kOe or more. The pressing pressure is 0.5 t/cm² or more.

(5) The press-molded product, for which magnetic orientation was conducted, was sintered at temperatures of 500° C. to 1100° C. in a vacuum (under a degree of vacuum of 1×10⁻³ torr or lower), in an inert gas such as Ar gas, or in a reduction atmosphere including, for example, Ar+5%H2.

(6) The sintered sample is a cube measuring 10 mm ×10 mm ×10 mm. A magnetizing magnetic field was applied in an anisotropic direction, and magnetic properties were evaluated.

This sintered magnet exhibited the following properties: the resistivity is 0.2 to 15 m Ω-cm, the residual magnetic flux density is 1.0 to 1.2 T, and the maximum energy product is 25 to 35 MGOe. Sintering proceeds while diffusion coupling of part of the fluorine compounds or rare earth elements is being carried out. On a part in contact with the fluorine compound on the surface of the NdFeB powder, fluorine diffuses into the frontmost surface of the NdFeB powder as well. Since oxygen is present in the fluorine compound, an oxygen-fluorine compound is also formed. The oxygen-fluorine compound is more brittle and easier to peel than the fluorine compound, so the growth of the oxygen-fluorine compound should be suppressed to increase the density of the formed body. This type of surface treatment by use of a fluorine compound can be applied to not only magnetic particles but also the surface of a bulk magnet. The resistivity of the sintered magnet fabricated by performing heat treatment for the above magnetic particles is 2 to 100 times higher as compared with the conventional sintered NdFeB magnet, which can suppress eddy current from flowing in the magnet and reduce loss in the magnet part. Accordingly, when the inventive magnet is used in a multi-pole motor, a high-frequency motor, a high-speed motor, or another motor in which a high-frequency magnetic field is applied to the magnet part, the loss in the magnet part can be lessened. Since this provides the same effect as when heat generation from the magnet is suppressed, the thermal decay of the magnet can be lessened. In addition, effects that the coercive force was increased and the magnetization curve angularity was improved were recognized, so this type of magnet can be used as a magnet that must be heat resistant.

[Twelfth Embodiment]

Treatment liquid for forming terbium fluorine compound coating films was prepared; a methanol solution including TbF₃ with a concentration of 1 g/20 mL was prepared. A rare earth sintered magnet block surface was coated as described below.

(1) A sintered NdFeB magnet measuring 10 mm ×10 mm ×10 mm is dipped into 20 mL of TbF₃ coating film forming treatment liquid. The solution was added until it was confirmed that the entire rare earth magnet magnetic particles were wetted.

(2) The rare earth magnet magnetic particles, obtained in (1), on which TbF₃ coating films were formed, were placed under a reduced pressure of 2 to 5 torr to remove the methanol solvent.

(3) The rare earth magnet magnetic particles from which the solvent was removed in (2) was moved to a ceramic board, and then heated at 200 ° C. for 30 minutes and at 400° C. for 30 minutes, under a reduced pressure of 1×10⁻⁵ torr.

(4) Heat treatment was performed at temperatures of 500#C to 1000° C. so as to cause diffusion.

(5) A prescribed magnetizing magnetic field was applied for magnification, and magnetic properties were evaluated.

The above treatment causes TbF₃, TbF_{3-X}(X is 2 or 3), or fluorine oxide to be formed on the sintered magnet block surface. The average film thickness of the fluorine compounds before heat treatment is 10 to 10,000 nm, while the particle diameters of the fluorine compounds are 10 to 100 nm as shown in FIG. 1. The resistivity of the sintered magnet block surface is increased by this surface treatment, and the magnetic properties of the block surface are improved. As in the first embodiment, improvements of the magnetic properties include increase in residual magnetic flux density, improvement of the angularity of a magnetization curve, and reduction in thermal demagnetization. On some formed portions, the resistivity measured by the four-terminal method is 0.2 m Ω-cm or more and the resistance between crystal grains particles measured by the two-terminal method by use of a scanning electron microscope (SEM) is about 10 times larger than when surface treatment is not performed. This type of NdFeB sintered magnet blocks can be coated with the following fluorine compounds in the same way: LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅ , AgF, InF₃, SnF₂, SnF₄, BaF₂, LaF₂, LaF₃, CeF₂, CeF₃, PrF₂, PrF₃, NdF₂, NdF₃, SmF₂, SmF₃, EuF₂, EuF₃, GdF₃, TbF₃, TbF₄, DyF₂, DyF₃, HoF₂, HoF₃, ErF₂, ErF₃, TmF₂, TmF₃, YbF₃, YbF₂, LuF₂, LuF₃, PbF₂, and BiF₃, as well as their fluorine oxides. NdDyFeB, NdFeCoB, and NdFeBAl of the NdFeB compounds as well as RE₂Fe₁₄B or RE₂Co₁₇ (RE is a rare earth element) of the Sm₂Co₁₇ compounds and the like can be applied to sintered magnet blocks; any rare earth sintered magnet can be coated with the above fluorine compounds or fluorine oxide. As for sintered magnet block sizes, the above improvements in the magnetic properties were recognized even in minute magnets measuring 10 μm ×10 μm ×10 μm. The improvements in the magnetic properties are assumed to be brought by large magnetic anisotropy in cracks on the magnet surface; the magnetic anisotropy being enlarged by a reaction between a parent phase and minute fluorine compounds applied to the cracks.

The present invention can suppress reduction in the coercive force of an R—Fe—B (R is a rare earth element) or RCo magnet and increase the energy product. Accordingly, the present invention is applicable to a magnet motor from which a high torque is obtained. Magnet motors of this type include a motor for driving a hybrid car, a motor for a stator, and a motor for electric power steering.

What is claimed is:

1. A magnetic material is including magnetic particles including a rare earth element, wherein a fluorine compound including an alkaline earth element or a rare earth element is formed on a surface of the magnetic particles, and an oxygen concentration of the fluorine compound is higher than an oxygen concentration of the magnetic particle.

2. A magnetic material according to claim 1, wherein the magnetic particle includes Nd, Fe, and B elements.

3. A magnetic material according to claim 1, wherein the magnetic particle includes Sm and Co elements.

4. A magnetic material according to claim 1, wherein the fluorine compound includes at least one type of element selected from the group consisting of the Li, Mg, Ca, Sc, V, Cr, Mn, Fe, Co, Ni, Zn, Al, Ga, Sr, Y, Zr, Nb, Ag, In, Sn, Ba, La, Ce, Pr, Nd, Sm, Eu, Gd, Tb, Dy, Ho, Er, Tm, Yb, Lu, Pb, and Bi elements.

5. A magnetic material according to claim 1, wherein a layer is formed near an interface between the fluorine compound and the magnetic particle on which the fluorine compound is formed, the layer has a higher saturated magnetic flux density than the magnetic particle.

6. A magnet which is fabricated by molding a magnetic material, wherein the magnetic material is including magnetic particles including a rare earth element, a fluorine compound including an alkaline earth element or a rare earth element is formed on a surface of the magnetic particles, and an oxygen concentration of the fluorine compound is higher than an oxygen concentration of the magnetic particle.

7. A rotating machine comprising a rotor having a magnet and a stator having a coil and the magnet is fabricated by molding a magnetic material, wherein the magnetic material is including magnetic particles including a rare earth element, a fluorine compound including an alkaline earth element or a rare earth element is formed on a surface of the magnetic particles, and an oxygen concentration of the fluorine compound is higher than an oxygen concentration of the magnetic particle.

8. A magnetic material is including magnetic particles including a rare earth element, wherein a fluorine compound including an alkaline earth element or a rare earth element is formed on a surface of the magnetic particles, and the fluorine compound is including a Fe element near an interface between the fluorine compound and the magnetic particle on which the fluorine compound is formed.

9. A magnetic material according to claim 8, wherein the magnetic particle includes Nd, Fe, and B elements.

10. A magnetic material according to claim 8, wherein the magnetic particle includes Sm and Co elements.

11. A magnetic material according to claim 8, wherein the fluorine compound includes at least one type of element selected from the group consisting of the Li, Mg, Ca, Sc, V, Cr, Mn, Fe, Co, Ni, Zn, Al, Ga, Sr, Y, Zr, Nb, Ag, In, Sn, Ba, La, Ce, Pr, Nd, Sm, Eu, Gd, Tb, Dy, Ho, Er, Tm, Yb, Lu, Pb, and Bi elements.

12. A magnet which is fabricated by molding a magnetic material, wherein the magnetic material is including magnetic particles including a rare earth element, a fluorine compound including an alkaline earth element or a rare earth element is formed on a surface of the magnetic particles, and the fluorine compound is including a Fe element near an interface between the fluorine compound and the magnetic particle.

13. A rotating machine comprising a rotor having a magnet and a stator having a coil and the magnet is fabricated by molding a magnetic material, wherein the magnetic material is including magnetic particles including a rare earth element, a fluorine compound including an alkaline earth element or a rare earth element is formed on a surface of the magnetic particles, and the fluorine compound is including a Fe element near an interface between the fluorine compound and the magnetic particle.

14. A magnetic material is including magnetic particles including a rare earth element, wherein a fluorine compound including an alkaline earth element or a rare earth element is formed on a surface of the magnetic particles, and an concentration of the rare earth element included in the magnetic particle in the fluorine compound is higher than an concentration of the rare earth element included in the magnetic particle in the magnetic particle near an interface between the magnetic particle and the fluorine compound.

15. A magnetic material according to claim 14, wherein the magnetic particle includes Nd, Fe, and B elements.

16. A magnetic material according to claim 14, wherein the magnetic particle includes Sm and Co elements.

17. A magnetic material according to claim 14, wherein the fluorine compound includes at least one type of element selected from the group consisting of the Li, Mg, Ca, Sc, V, Cr, Mn, Fe, Co, Ni, Zn, Al, Ga, Sr, Y, Zr, Nb, Ag, In, Sn, Ba, La, Ce, Pr, Nd, Sm, Eu, Gd, Tb, Dy, Ho, Er, Tm, Yb, Lu, Pb, and Bi elements.

18. A magnetic material according to claim 14, wherein a layer is formed near the interface between the fluorine compound and the magnetic particle on which the fluorine compound is formed, the layer has a higher saturated magnetic flux density than the magnetic particle.

19. A magnet which is fabricated by molding a magnetic material, wherein the magnetic material is including magnetic particles including a rare earth element, a fluorine compound including an alkaline earth element or a rare earth element is formed on a surface of the magnetic particles, and an concentration of the rare earth element included in the magnetic particle in the fluorine compound is higher than an concentration of the rare earth element included in the magnetic particle in the magnetic particle near an interface between the magnetic particle and the fluorine compound.

20. A rotating machine comprising a rotor having a magnet and a stator having a coil and the magnet is fabricated by molding a magnetic material, wherein the magnetic material is including magnetic particles including a rare earth element, a fluorine compound including an alkaline earth element or a rare earth element is formed on a surface of the magnetic particles, and an concentration of the rare earth element included in the magnetic particle in the fluorine compound is higher than an concentration of the rare earth element included in the magnetic particle in the magnetic particle near an interface between the magnetic particle and the fluorine compound.
